(19) United States
(12) Patent Application Publication
(10) Pub. No.: US 2022/0022357 A1
(43) Pub. Date: Jan. 27, 2022

(54) AGRICULTURAL SWEEP WITH WEAR RESISTANT COATING

(71) Applicant: Osmundson Mfg. Co., Perry, IA (US)

(72) Inventor: Douglas G. Bruce, West Des Moines, IA (US)

(21) Appl. No.: 16/934,741

(22) Filed: Jul. 21, 2020

(51) Int. Cl. A01B 15/02

(52) U.S. Cl. CPC A01B 15/025

(57) ABSTRACT

An agricultural device with a wear resistant coating comprising a shank portion that may be attached to an agricultural implement. First and second rear wings connect to an intermediate portion that connects to the shank portion. First and second shoulders are formed at the points where the rear wings meet the intermediate portion, and a patch of wear resistant coating is applied at each of the first and second shoulders. A first edge tapers forwardly from the first rear wing to a point, and a second edge tapers forwardly from the second rear wing to the point. Wear resistant coating may also be applied to the first and second edges or the point. Wear resistant coating may be applied to the agricultural device in a pattern that is specific to soil type.

### FIELD OF THE DISCLOSURE

This disclosure relates generally to an agricultural device with a wear resistant coating, and in particular to an agricultural sweep with a wear resistant coating. In one arrangement, the disclosure relates to an agricultural sweep having a patch of wear resistant coating applied to the leading edge of the agricultural sweep. In another arrangement, the disclosure relates to an agricultural sweep having patches of wear resistant coating applied at the trailing edge of the agricultural sweep. Patches of wear resistant coating may be applied in patterns that are specific to soil type.

### BACKGROUND OF THE DISCLOSURE

Various tillage devices are used to turn and work soil for agricultural purposes. One type of tillage device is a sweep. An agricultural sweep is typically mounted to a gang implement which holds a number of sweeps at a position in which the sweeps travel just below the surface of the earth between crop rows. The purpose of the sweeps is to cut weeds just below the ground surface, thus inhibiting the growth of the weeds and promoting the growth of the row crops.

Various designs for agricultural sweeps exist, an example of which is U.S. Pat. No. 6,508,147 (Bruce). Due to the abrasive nature of the soil that sweeps and other ground engaging agricultural devices encounter, such devices become worn and periodically require replacement. Wear resistant coatings have been applied to the leading edges of ground engaging agricultural devices; however, the trailing edge is also subject to wear. In the case of an agricultural sweep, wear of the trailing edge is particularly problematic as trailing edge wear erodes the area at which the sweep attaches to the implement. Advanced wear of the trailing edge can cause the sweep to break off the implement, and the crop rows adjacent to the broken sweep may remain unworked until the breakage is discovered and remedied.

Replacement of ground engaging agricultural devices leads to expense and down time while the worn part is replaced.

For the reasons stated above and for other reasons which will become apparent to those skilled in the art upon reading and understanding the specification, there is a need in the art for an improved agricultural device with wear resistant coating.

Thus it is a primary object of the disclosure to provide an agricultural device with wear resistant coating that prevents wear on the leading edge, trailing edge, or both leading and trailing edges of the device.

These and other objects, features, or advantages of the present disclosure will become apparent from the specification and claims.

### BRIEF SUMMARY OF THE DISCLOSURE

The disclosure relates to an improved agricultural device with wear resistant coating. The disclosure relates to an agricultural sweep with wear resistant coating. The disclosure relates to application of wear resistant coating on the leading and trailing edges of an agricultural device.

### BRIEF DESCRIPTION OF THE DRAWINGS

FIG. 1 depicts a perspective view of an agricultural device with wear coating according to one embodiment.

FIG. 2 depicts a top view of an agricultural device with wear coating according to one embodiment.

FIG. 3 depicts a perspective view of a typical wear pattern experienced by an agricultural device according to one embodiment.

FIG. 4 depicts a perspective view of an agricultural device attached to a shank of an earth working implement and moving through soil according to one embodiment.

FIG. 5 depicts a perspective view of an agricultural device with wear coating according to one embodiment.

FIG. 6 depicts a top view of an agricultural device with wear coating according to one embodiment.

FIG. 7 depicts a top view of an agricultural device with wear coating applied in a pattern specific to sandy or abrasive soil that is moist, wet, and sticky according to one embodiment.

FIG. 8 depicts a top view of an agricultural device with wear coating applied in a pattern specific to rocky soil that is moist, wet, and sticky according to one embodiment.

FIG. 9 depicts a top view of an agricultural device with wear coating applied in a pattern specific to black soil that is moist, wet, and sticky according to one embodiment.

FIG. 10 depicts a bottom view of an agricultural device with wear coating according to one embodiment.

FIG. 11 depicts a top view of an agricultural device with wear coating applied in a pattern specific to loose and sandy or abrasive soil according to one embodiment.

FIG. 12 depicts a top view of an agricultural device with wear coating applied in a pattern specific to loose and rocky soil according to one embodiment.

FIG. 13 depicts a top view of an agricultural device with wear coating applied in a pattern specific to loose and black soil according to one embodiment.

FIG. 14 depicts an agricultural device with wear coating applied in a custom pattern for a specific user's unique soil type according to one embodiment.

FIG. 15 depicts an agricultural device with wear coating applied in a custom pattern for a specific user's unique soil type according to one embodiment.

FIG. 16 depicts an agricultural device with wear coating applied in a custom pattern for a specific user's unique soil type according to one embodiment.

FIG. 17 depicts an agricultural device with wear coating applied in a custom pattern for a specific user's unique soil type according to one embodiment.

FIG. 18 depicts an agricultural device with wear coating applied in a custom pattern for a specific user's unique soil type according to one embodiment.

FIG. 19 depicts an agricultural device with wear coating applied in a custom pattern for a specific user's unique soil type according to one embodiment.

FIG. 20 depicts an agricultural device with wear coating applied in a custom pattern for a specific user's unique soil type according to one embodiment.

FIG. 21 depicts an agricultural device with wear coating applied in a custom pattern for a specific user's unique soil type according to one embodiment.

FIG. 22 depicts an agricultural device with wear coating applied in a custom pattern for a specific user's unique soil type according to one embodiment.

FIG. 23 depicts an agricultural device with wear coating applied in a custom pattern for a specific user's unique soil type according to one embodiment.

FIG. 24 depicts an agricultural device with wear coating applied in a custom pattern for a specific user's unique soil type according to one embodiment.

FIG. 25 depicts an agricultural device with wear coating applied in a custom pattern for a specific user's unique soil type according to one embodiment.

FIG. 26 depicts an agricultural device with wear coating applied in a custom pattern for a specific user's unique soil type according to one embodiment.

FIG. 27 depicts an agricultural device with wear coating applied in a custom pattern for a specific user's unique soil type according to one embodiment.

FIG. 28 depicts an agricultural device with wear coating applied in a custom pattern for a specific user's unique soil type according to one embodiment.

FIG. 29 depicts an agricultural device with wear coating applied in a custom pattern for a specific user's unique soil type according to one embodiment.

FIG. 30 depicts an agricultural device with wear coating applied in a custom pattern for a specific user's unique soil type according to one embodiment.

FIG. 31 depicts an agricultural device with wear coating applied in a custom pattern for a specific user's unique soil type according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

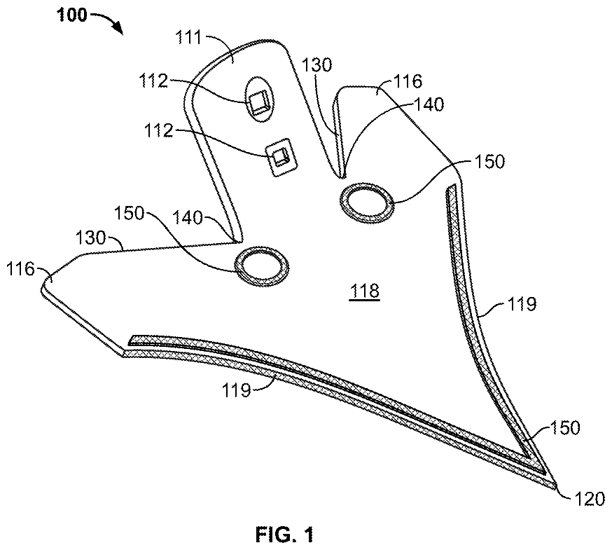

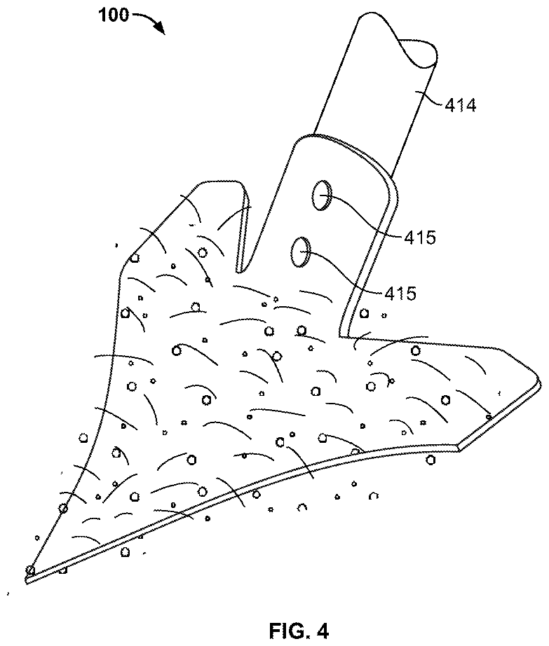

Throughout the disclosure, agricultural device 100 may be referred to as simply “device 100.” As shown in FIGS. 1, 2, 5, and 6, an example of an agricultural device 100 comprises a shank portion 111 with holes 112 therein for allowing the shank portion 111 to be attached to a shank 414 of an agricultural tillage implement with bolts 415 as shown in FIG. 4. First and second rear wings 116 are connected by an intermediate portion 118.

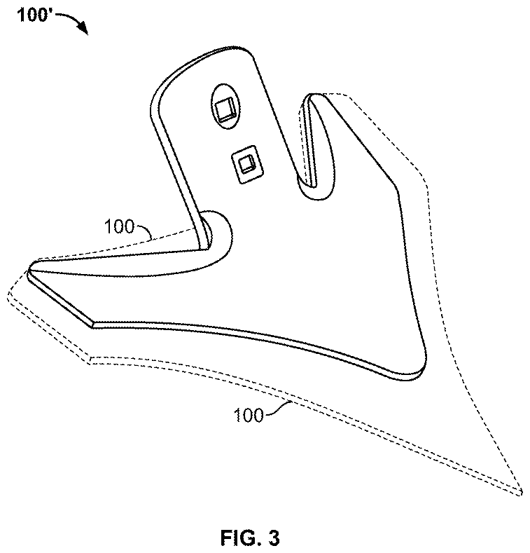

Edges 119 taper forwardly from a trailing edge 130 to a tip 120. The edges 119 and tip 120 together form a portion of device 100 referred to as the leading edge. The points at which the rear wings 116 meet the intermediate portion 118 are referred to as the shoulders 140. Tip 120 may have nominal width (i.e., the lines of edges 119 intersect at the tip 120 forming a point), or tip 120 may form a chisel point that is at least ½ inch wide from one side to the other side and which is tapered in thickness from having practically no thickness at the extreme front thereof to a rear portion thereof which is substantially the same thickness as the plate from which the entire sweep is constructed. The device 100 gradually wears from the original shape shown in FIG. 3 in dashed lines to the condition 100′ shown in solid lines in FIG. 3. Having a chisel point at tip 120 and having more material in the device 100 itself enhances the life and performance of the device 100. The shape of device 100 is substantially similar to the earth working sweep disclosed in U.S. Pat. No. 6,508,147, which is incorporated herein by reference.

The device 100 may be constructed from steel or any other metal or material suitable for use as a ground-engaging device. The device 100 can be as wide or narrow as desired. A number of devices 100 can be cut from a single sheet of material in order to conserve the material, reduce waste and give the farmer as much material as possible in order to enhance the performance and longevity of the device 100 to be made therefrom. After cutting a number of devices 100 from a single sheet of material, the flat pieces cut from the material are shaped to form the various parts of device 100 described in this disclosure.

As shown in FIG. 4, in operation, soil (depicted as curved lines and dots) first encounters device 100 at tip 120 and edges 119. The soil continues to move across device 100 as device 100 is propelled through the soil, and the soil that travels over the top of device 100 ultimately moves off device 100 at its trailing edge 130. As shown in FIG. 3, the device 100 gradually wears from its original shape 100 shown in dashed lines to the condition 100′ shown in solid lines. Wear occurs at the tip 120 and edges 119 as a result of encountering soil, rocks, roots, and other objects. Significant wear also occurs at the trailing edge 130, and particularly at the shoulders 140.

To extend the useful life of device 100, a wear resistant coating 150 may be applied at tip 120, edges 119, shoulders 140, or trailing edge 130, or any combination of tip 120, edges 119, shoulders 140, and trailing edge 130. Wear resistant coating 150 may comprise carbide particles, tungsten carbide coating, and the like. However, wear resistant coating 150 may be comprised of any material or composition without departing from the disclosure. The wear resistant coating 150 may be applied to device 100 using any application method. For example, wear resistant coating 150 may be welded, sprayed, rolled, brushed, dabbed, etched, deposited, applied by laser, deposited by plasma or detonation gun, or brushed onto device 100. Alternatively, device 100 may be dipped in wear resistant coating 150.

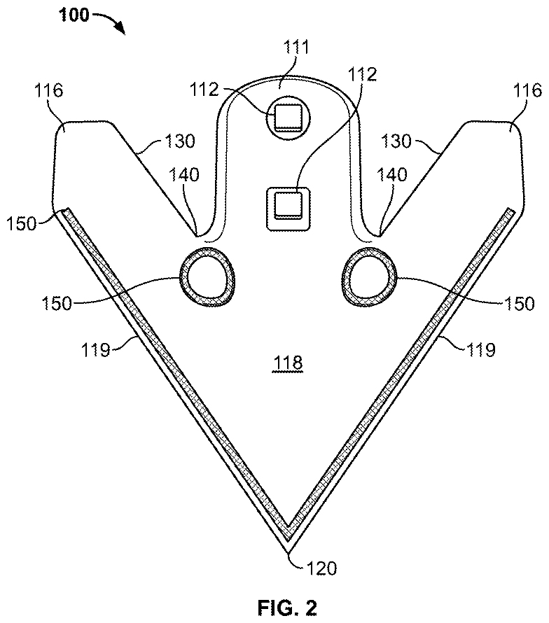

Wear Resistant Coating 150 on the Leading Edge as Shown in FIGS. 1 and 2

As shown in FIGS. 1 and 2, wear resistant coating 150 may be applied to the leading edge of device 100. A line of wear resistant coating 150 may be applied to the tip 120. Additionally or alternatively, a line of wear resistant coating 150 may be applied to or near edges 119 or a portion of edges 119. Wear resistant coating 150 may be applied to the top, bottom or side of tip 120 and/or edges 119. Wear resistant coating 150 may be applied to the shoulders 140 in addition to the leading edge of device 100, or wear resistant coating 150 may be applied to the leading edge only.

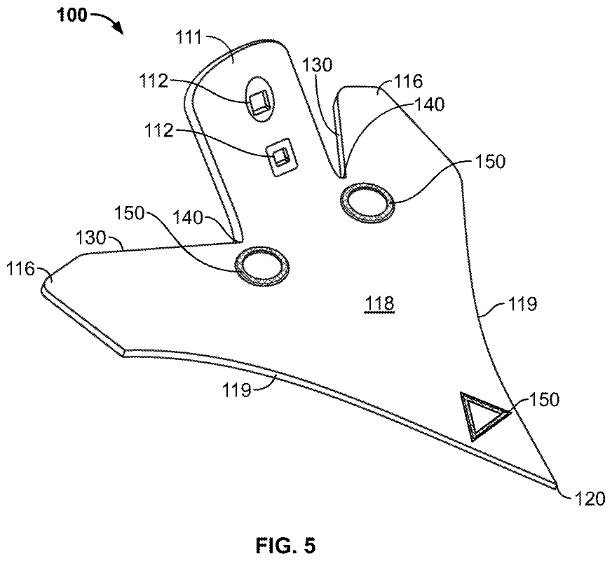

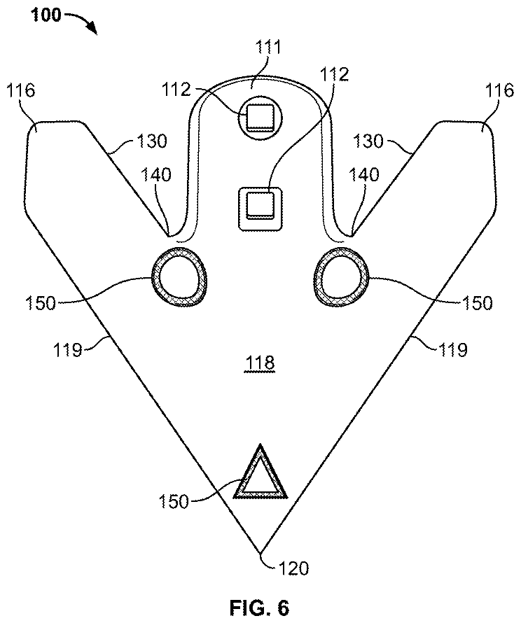

Wear Resistant Coating 150 on the Leading Edge as Shown in FIGS. 5 and 6

As shown in FIGS. 5 and 6, wear resistant coating 150 may be applied to the leading edge of device 100. A patch of wear resistant coating 150 may be applied at the tip 120 only. The patch of wear resistant coating 150 may comprise a triangular, circular, semi-circular, square or any other shaped patch of wear resistant coating 150 that completely or partially covers tip 120. The patch of wear resistant coating 150 may be applied to the top, bottom or side of tip 120. By preventing wear on tip 120, which is the point at which most wear experienced by device 100 occurs, wear along edges 119 is also reduced without applying wear resistant coating 150 to edges 119. Thus, by limiting the application of wear resistant coating 150 to a patch on tip 120, the time and expense of applying wear resistant coating 150 is reduced while reducing wear on the entire leading edge of device 100. Wear resistant coating 150 may be applied to the shoulders 140 in addition to the leading edge of device 100, or wear resistant coating 150 may be applied to the tip 120 only.

Wear Resistant Coating 150 on the Trailing Edge as Shown in FIGS. 1, 2, 5, and 6

As shown in FIGS. 1, 2, 5, and 6, wear resistant coating 150 may be applied at each shoulder 140. The patches of wear resistant coating 150 may comprise triangular, circular, semi-circular, square or any other shaped patches of wear resistant coating 150 that completely or partially cover shoulders 140. The patches of wear resistant coating 150 may be applied to the top, bottom or side of shoulders 140. Wear resistant coating 150 may be applied to the leading edge or tip 120 in addition to the shoulders 140, or wear resistant coating 150 may be applied to the shoulders 140 only.

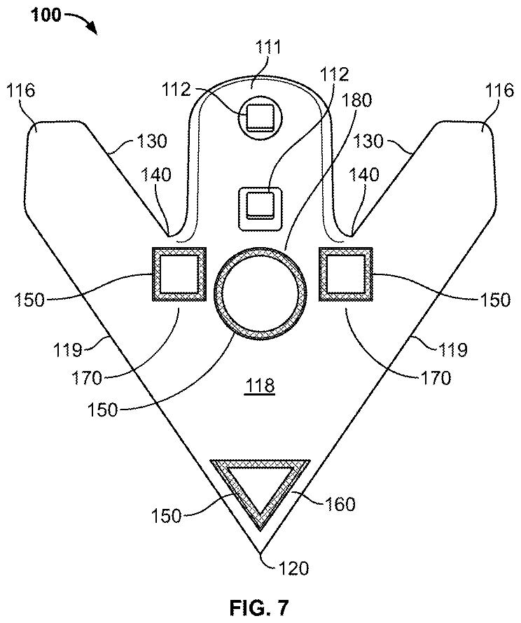

Wear Resistant Coating 150 Patterns Based on Soil Type as Shown in FIGS. 7-13

Agricultural soil type varies from location to location, and soil type affects the wear pattern agricultural device 100 experiences. The main areas where wear occurs on agricultural device 100 are the tip 120, the shoulders 140, and the shank portion 111. Wear resistant coating 150 may be applied in differing patterns based on soil type as shown in FIGS. 7-13. The shape of each patch of wear resistant coating 150 directs the wear pattern that will be experienced by device 100.

In FIGS. 7-9 and FIGS. 11-13, a first patch of wear resistant coating 150 is applied in a soil-specific pattern to a first location 160 on the top side of agricultural device 100 at or near tip 120 with the objective of protecting the tip 120 from wear. A second patch of wear resistant coating 150 is applied in a soil-specific pattern to a second location 170 on the top side of agricultural device 100 at or near each shoulder 140 with the objective of protecting the shoulders 140 and shank portion 111 from wear. A third patch of wear resistant coating 150 may optionally be applied in a soil-specific pattern to a third location 180 on the top side of agricultural device 100 at or near the shank portion 111 with the objective of protecting the shoulders 140 and shank portion 111 from wear. Ideally, patches of wear resistant coating 150 are placed in each of the first location 160, second location 170, and third location 180; however, patches of wear resistant coating 150 may be applied to any combination or subset of the first location 160, second location 170, and third location 180 or may be applied to any other location on the surface of the device 100 without departing from the scope of the disclosure. Patches of wear resistant coating 150 may be applied to any part of the surface of the device 100; however, best results occur when wear resistant coating 150 is placed one inch or less from the location where wear starts. Wear resistant coating 150 may be applied in any thickness without departing from the scope of the disclosure.

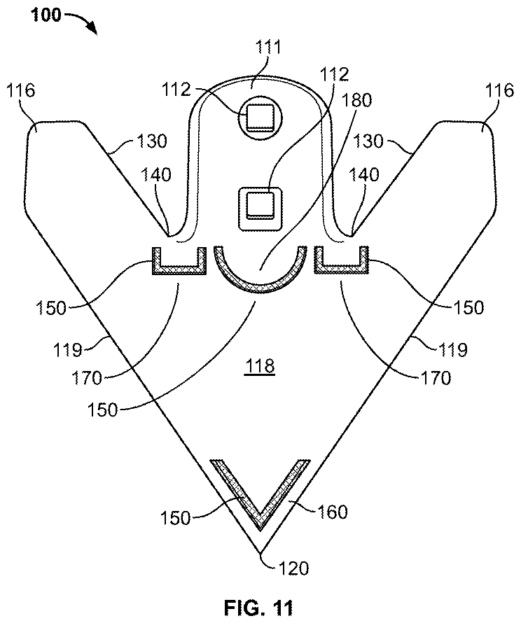

Patches of wear resistant coating 150 may be solid, filled in shapes; however, it is anticipated that the patches of wear resistant coating 150 will comprise shapes that are open in the center (i.e. shapes that are not filled in or have openings like a donut's shape). Further, patches of wear resistant coating 150 may be closed shapes in which the entire perimeter of the shape is applied as shown in FIGS. 7-9, or patches of wear resistant coating may be open shapes in which a portion of the perimeter of the shape is omitted as shown in FIGS. 11-13. Closed shapes are ideal for soil that is moist, wet, and sticky. Open shapes are ideal for loose soil.

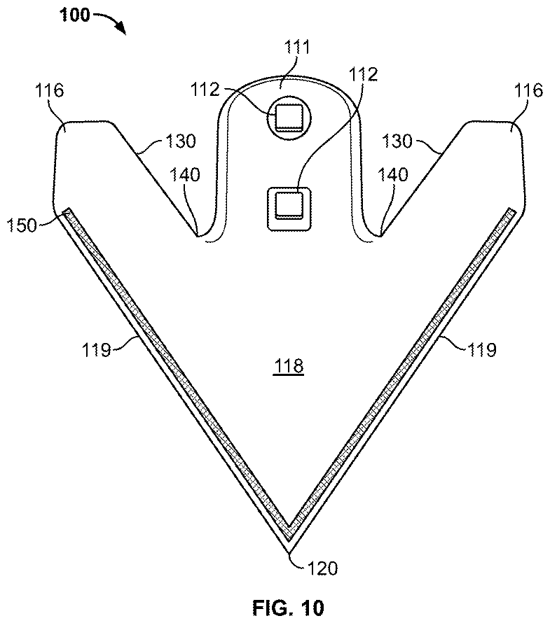

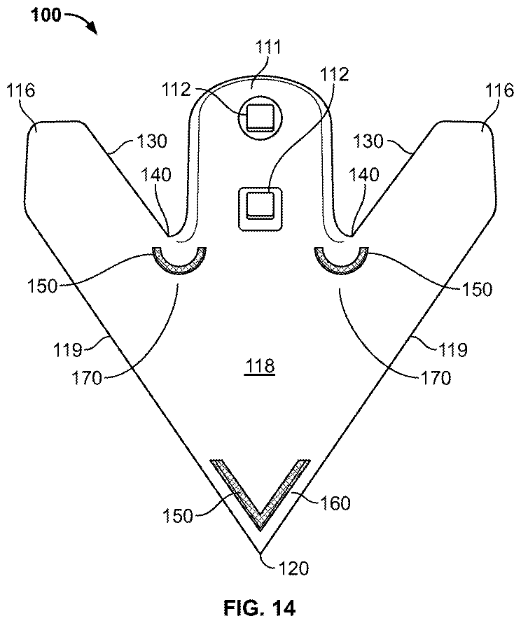

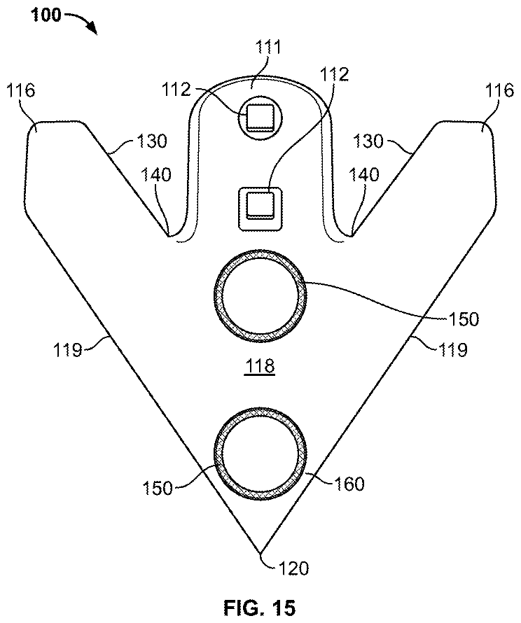

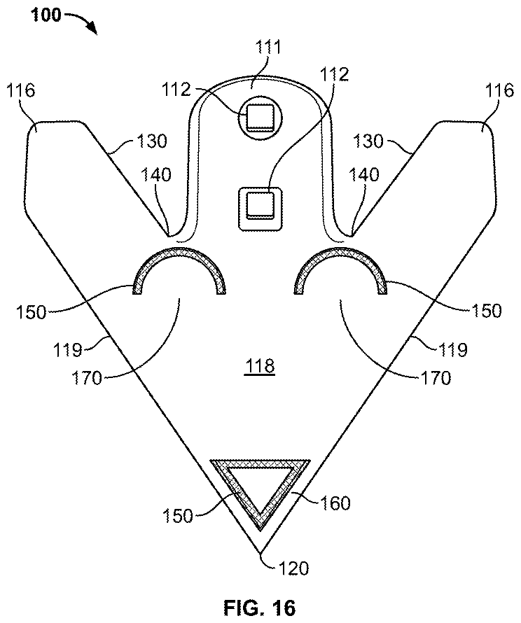

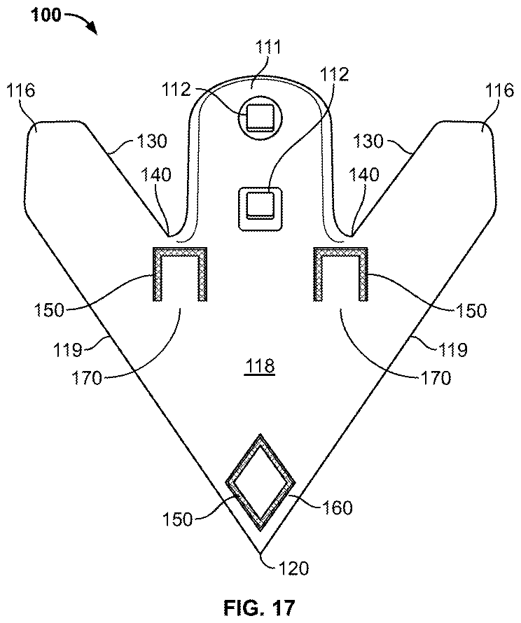

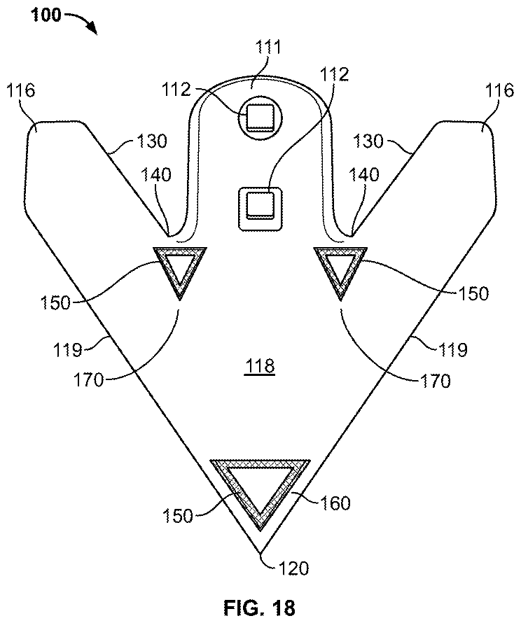

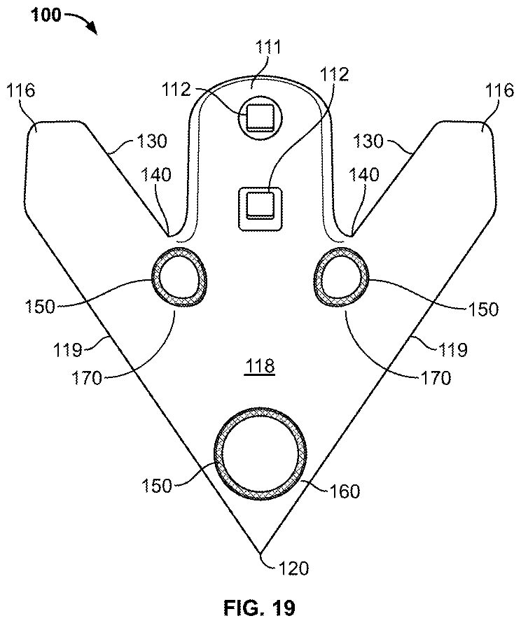

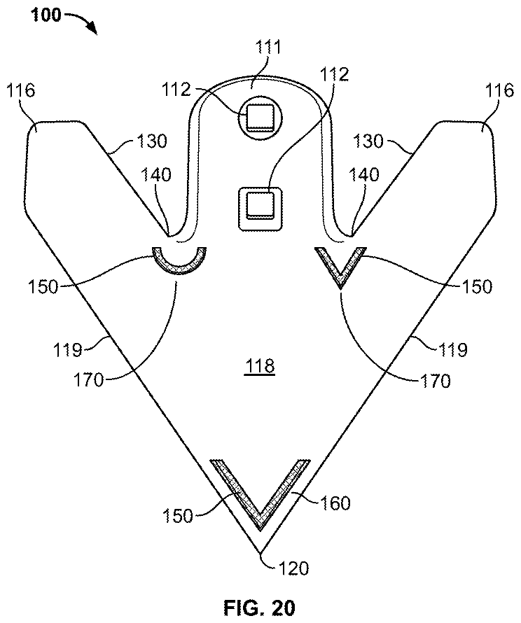

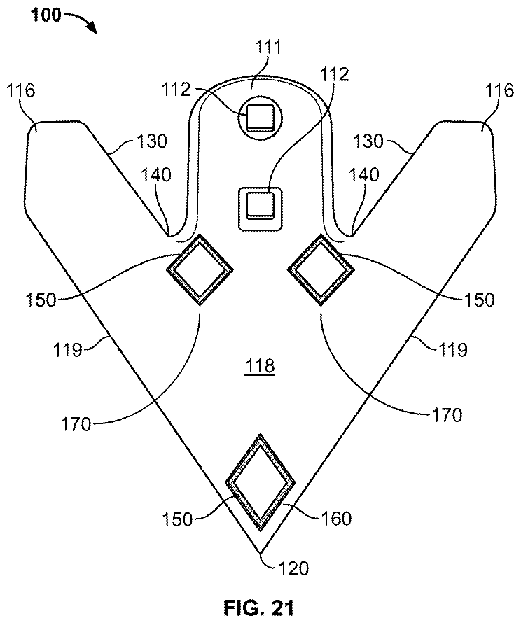

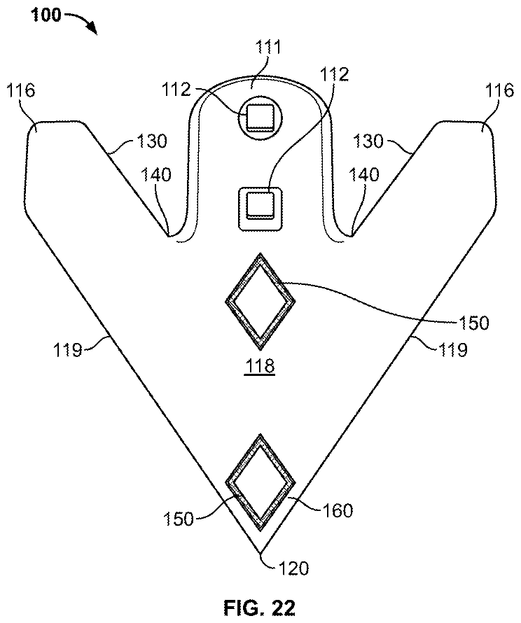

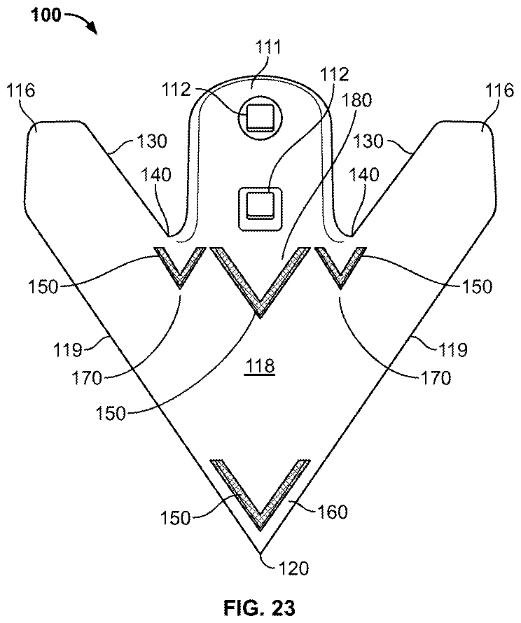

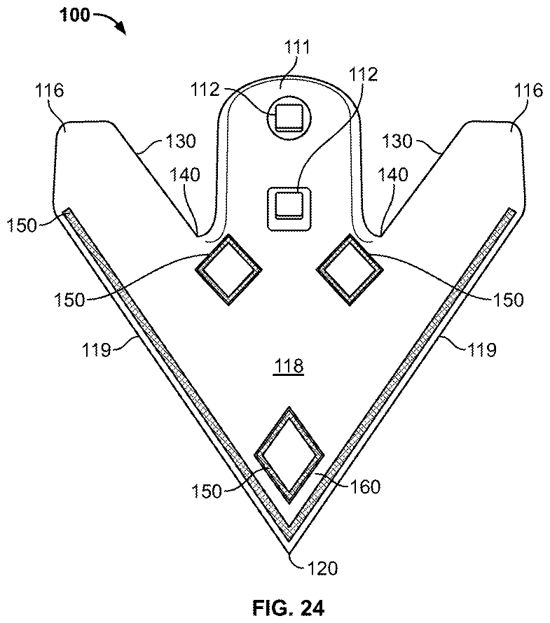

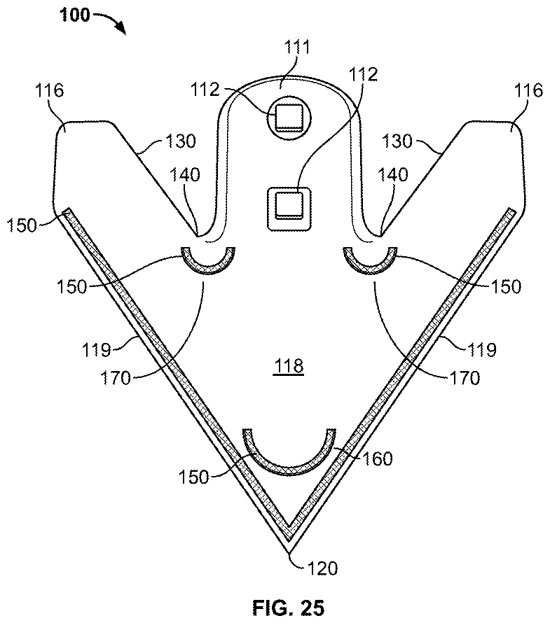

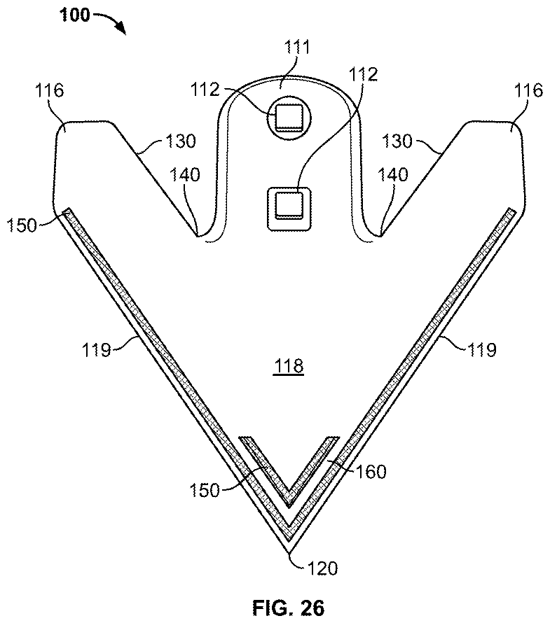

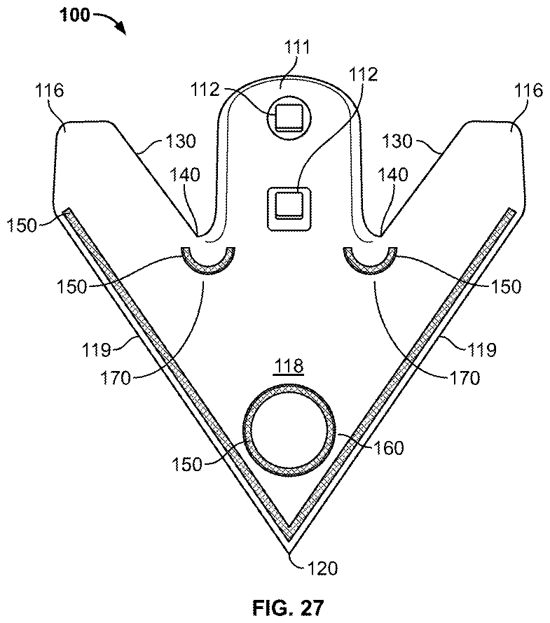

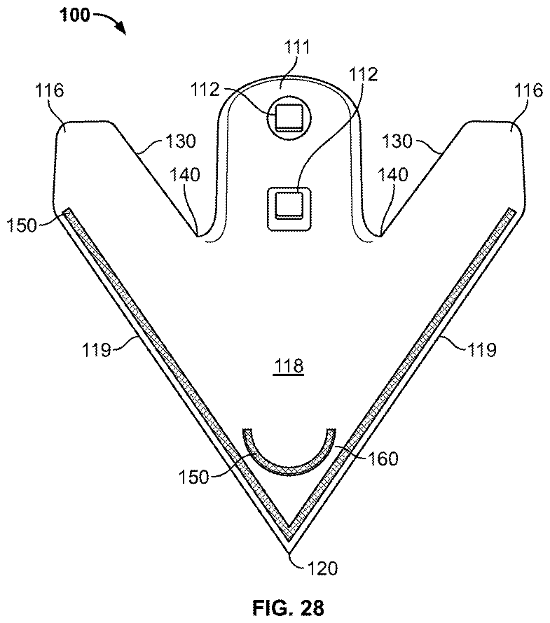

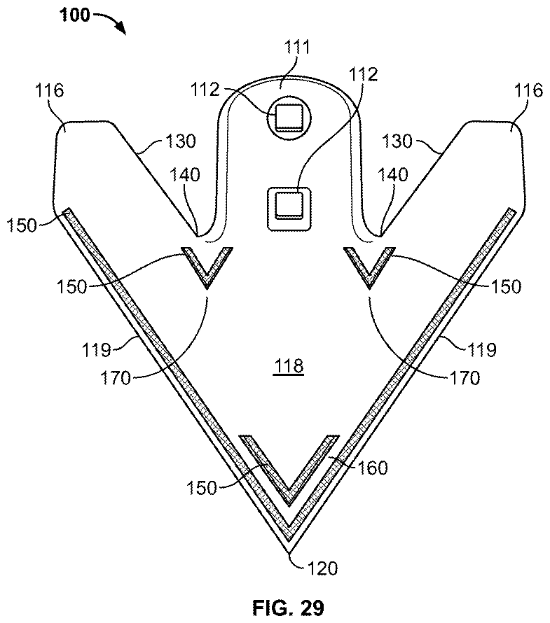

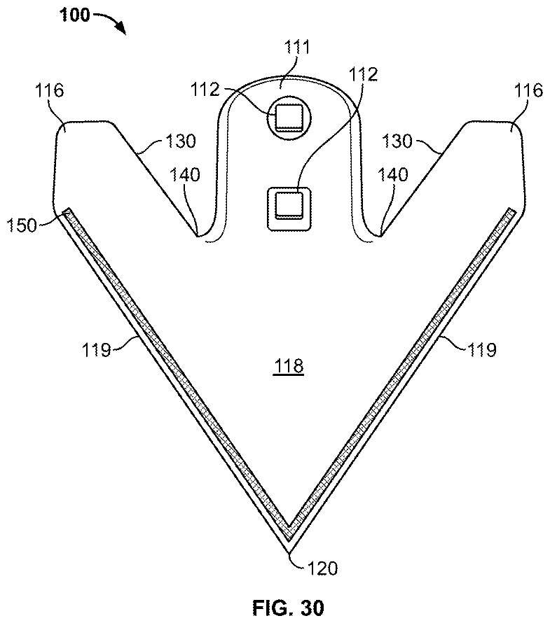

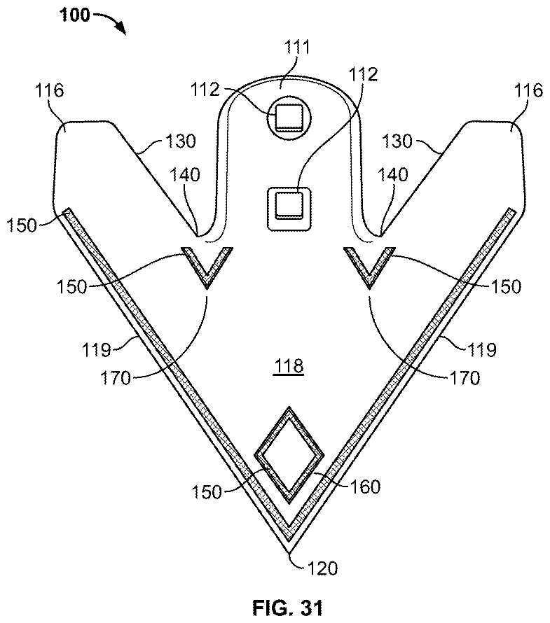

As shown in FIG. 7, wear resistant coating 150 may be applied to the top side of agricultural device 100 in a pattern specific to sandy or abrasive soil that is also moist, wet, and sticky. To protect tip 120, a generally triangular and closed patch of wear resistant coating 150 is applied to a first location 160 on the top side of agricultural device 100. To protect shoulders 140 and shank portion 111, generally square and closed patches of wear resistant coating 150 are applied at each second location 170 on the top side of agricultural device 100. To provide further protection for shoulders 140 and shank portion 111, a generally circular and closed patch of wear resistant coating 150 may optionally be applied at a third location 180 on the top side of agricultural device 100. As shown in FIG. 10, a line of wear resistant coating 150 may be applied along all or part of the leading edge of agricultural device 100 to provide further protection of the leading edge and tip 120 from wear. The term “sandy” soil refers to a generally abrasive soil type, and there are many different types of sandy soils including soft sandy soil, sandy soil with pea rock, sandy soil with large rocks, and other abrasive soils. Due to the wide variety of sandy soil types, it is difficult to predict which pattern of wear resistant coating 150 will be most effective at preventing wear on an agricultural device 100. Customers may submit worn agricultural devices 100 to the manufacturer for analysis of wear patterns, and subsequent agricultural devices 100 produced for that individual customer will have customized wear resistant coating 150 patterns that are most effective for the customer's specific soil type. Several examples of custom patterns of wear coating 150 applied to agricultural devices 100 are shown in FIGS. 14-31.

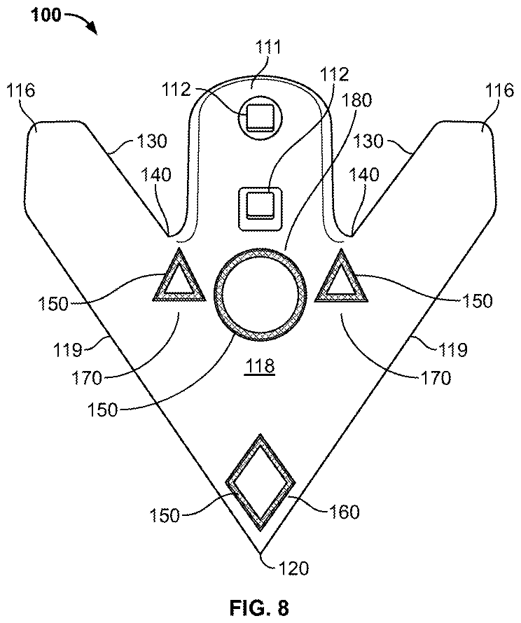

As shown in FIG. 8, wear resistant coating 150 may be applied to the top side of agricultural device 100 in a pattern specific to rocky soil that is also moist, wet, and sticky. To protect tip 120, a generally square and closed patch of wear resistant coating 150 is applied to a first location 160 on the top side of agricultural device 100. To protect shoulders 140 and shank portion 111, generally triangular and closed patches of wear resistant coating 150 are applied at each second location 170 on the top side of agricultural device 100. To provide further protection for shoulders 140 and shank portion 111, a generally circular and closed patch of wear resistant coating 150 may optionally be applied at a third location 180 on the top side of agricultural device 100. As shown in FIG. 10, a line of wear resistant coating 150 may be applied along all or part of the leading edge of agricultural device 100 to provide further protection of the leading edge and tip 120 from wear.

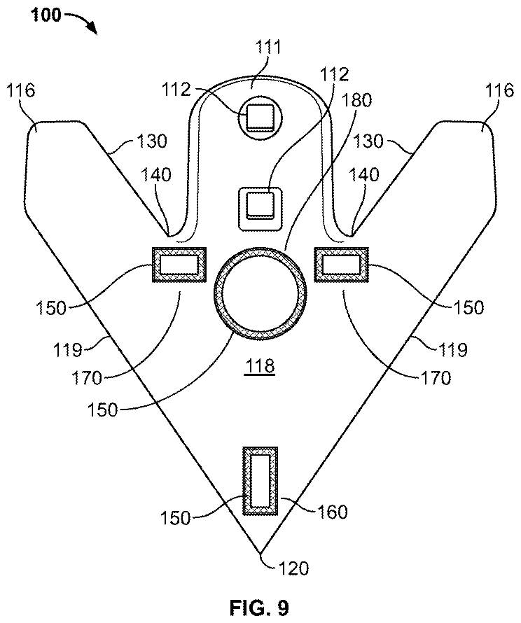

As shown in FIG. 9, wear resistant coating 150 may be applied to the top side of agricultural device 100 in a pattern specific to black soil that is also moist, wet, and sticky. To protect tip 120, a generally rectangular and closed patch of wear resistant coating 150 is applied to a first location 160 on the top side of agricultural device 100. To protect shoulders 140 and shank portion 111, generally rectangular and closed patches of wear resistant coating 150 are applied at each second location 170 on the top side of agricultural device 100. To provide further protection for shoulders 140 and shank portion 111, a generally circular and closed patch of wear resistant coating 150 may optionally be applied at a third location 180 on the top side of agricultural device 100. As shown in FIG. 10, a line of wear resistant coating 150 may be applied along all or part of each edge 119 of agricultural device 100 to provide further protection of the leading edge and tip 120 from wear.

As shown in FIG. 11, wear resistant coating 150 may be applied to the top side of agricultural device 100 in a pattern specific to sandy or abrasive soil that is also loose. To protect tip 120, a generally triangular and open patch of wear resistant coating 150 is applied to a first location 160 on the top side of agricultural device 100. To protect shoulders 140 and shank portion 111, generally square and open patches of wear resistant coating 150 are applied at each second location 170 on the top side of agricultural device 100. To provide further protection for shoulders 140 and shank portion 111, a generally circular and open patch of wear resistant coating 150 may optionally be applied at a third location 180 on the top side of agricultural device 100. As shown in FIG. 10, a line of wear resistant coating 150 may be applied along all or part of the leading edge of agricultural device 100 to provide further protection of the leading edge and tip 120 from wear. The term “sandy” soil refers to a generally abrasive soil type, and there are many different types of sandy soils including soft sandy soil, sandy soil with pea rock, sandy soil with large rocks, and other abrasive soils. Due to the wide variety of sandy soil types, it is difficult to predict which pattern of wear resistant coating 150 will be most effective at preventing wear on an agricultural device 100. Customers may submit worn agricultural devices 100 to the manufacturer for analysis of wear patterns, and subsequent agricultural devices 100 produced for that individual customer will have customized wear resistant coating 150 patterns that are most effective for the customer's specific soil type. Several examples of custom patterns of wear coating 150 applied to agricultural devices 100 are shown in FIGS. 14-31.

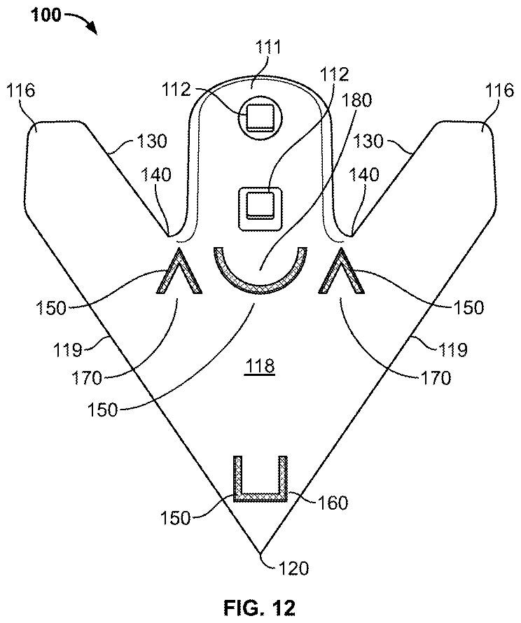

As shown in FIG. 12, wear resistant coating 150 may be applied to the top side of agricultural device 100 in a pattern specific to rocky soil that is also loose. To protect tip 120, a generally square and open patch of wear resistant coating 150 is applied to a first location 160 on the top side of agricultural device 100. To protect shoulders 140 and shank portion 111, generally triangular and open patches of wear resistant coating 150 are applied at each second location 170 on the top side of agricultural device 100. To provide further protection for shoulders 140 and shank portion 111, a generally circular and open patch of wear resistant coating 150 may optionally be applied at a third location 180 on the top side of agricultural device 100. As shown in FIG. 10, a line of wear resistant coating 150 may be applied along all or part of the leading edge of agricultural device 100 to provide further protection of the leading edge and tip 120 from wear.

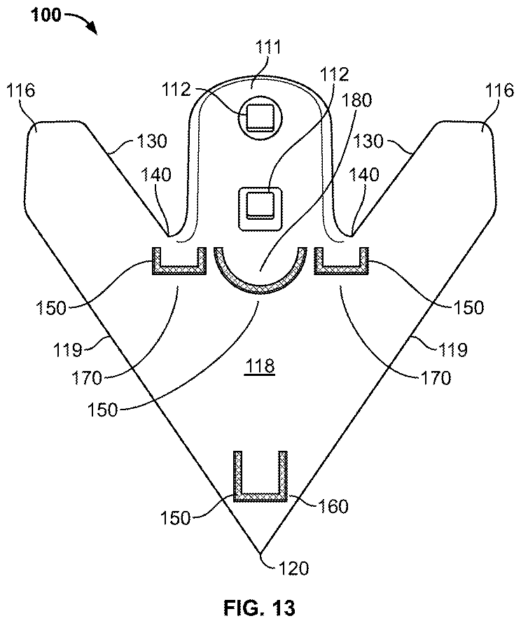

As shown in FIG. 13, wear resistant coating 150 may be applied to the top side of agricultural device 100 in a pattern specific to black soil that is also loose. To protect tip 120, a generally rectangular and open patch of wear resistant coating 150 is applied to a first location 160 on the top side of agricultural device 100. To protect shoulders 140 and shank portion 111, generally rectangular and open patches of wear resistant coating 150 are applied at each second location 170 on the top side of agricultural device 100. To provide further protection for shoulders 140 and shank portion 111, a generally circular and open patch of wear resistant coating 150 may optionally be applied at a third location 180 on the top side of agricultural device 100. As shown in FIG. 10, a line of wear resistant coating 150 may be applied along all or part of each edge 119 of agricultural device 100 to provide further protection of the leading edge and tip 120 from wear.

Each soil-specific pattern of wear resistant coating 150 previously described in this disclosure is considered ideal for most instances of the soil type described; however soil types are highly variable. In particular, there are many types of sandy or abrasive soils, each of which may produce a unique wear pattern. It is anticipated that some equipment owners may experience different wear patterns based on their specific soil, and the shapes, dimensions, and locations of wear resistant coating 150 may be customized to counter specific wear patterns. Further, shapes, dimensions, locations, and thicknesses of wear resistant coating 150 may be customized to achieve an acceptable balance of wear resistant properties and manufacturing cost for a particular customer. Customers may submit worn agricultural devices 100 to the manufacturer for analysis of wear patterns, and subsequent agricultural devices 100 produced for that individual customer will have customized wear resistant coating 150 patterns that are most effective for the customer's specific soil type. Each of FIGS. 14-31 depicts an agricultural device 100 with a custom pattern of wear resistant coating 150 produced to address a specific customer's unique wear pattern caused by their soil type.

Each patch of wear resistant coating 150 may be applied as shown in FIG. 7, 8, 9, 11, 12, or 13; alternatively any patch of wear resistant coating 150 may be rotated by 90 to 180 degrees. Further, it is envisioned that patches of wear resistant coating 150 will be applied to the first location 160, second location 170, and third location 180 on the top side of agricultural device 100 and a line of wear resistant coating 150 applied to each edge 119 on the bottom side of agricultural device 100 as shown and previously described; however, the patches of wear resistant coating 150 may alternatively be applied to a location corresponding to the first location 160, a location corresponding to the second location 170, and a location corresponding to the third location 180 on the bottom side of agricultural device 100 and a line of wear resistant coating 150 applied to each edge 119 on the top side of agricultural device 100 without departing from the scope of the disclosure.

The agricultural device 100 with wear resistant coating 150 has many benefits and advantages including, but not limited to reducing the expense and lost working time associated with replacing worn ground engaging components. These and other benefits and advantages of the agricultural device 100 are apparent from the specification and claims.

### REFERENCE NUMERALS

100—agricultural device, also called device
100′—a worn condition of agricultural device 100
111—shank portion
112—hole in shank portion 111
116—rear wing
118—intermediate portion
119—edges
120—tip
130—trailing edge
140—shoulders
150—wear resistant coating
160—first location
170—second location
180—third location
414—shank
415—bolt

What is claimed:

1. A wear resistant agricultural device comprising:
a shank portion configured for attachment to a tillage implement;
a first rear wing and a second rear wing, wherein the first and second rear wings are connected to an intermediate portion and an end of the intermediate portion connects to the shank portion, thereby forming a first shoulder where the first rear wing meets the intermediate portion and a second shoulder where the second rear wing meets the intermediate portion;
a first edge tapering forwardly from the first rear wing to a point,
a second edge tapering forwardly from the second rear wing to the point; and
a patch of wear resistant coating applied at each of the first and second shoulders.

2. The wear resistant agricultural device of claim 1 wherein a patch of wear resistant coating is applied at the point and the first and second edges are uncoated.

3. The wear resistant agricultural device of claim 1 further comprising a wear resistant coating applied to each of the first and second edges and the point.

4. The wear resistant agricultural device of claim 1 wherein the wear resistant coating comprises carbide particles.

5. A wear resistant agricultural device comprising:
a shank portion configured for attachment to a tillage implement;
a first rear wing and a second rear wing, wherein the first and second rear wings are connected to an intermediate portion and an end of the intermediate portion connects to the shank portion, thereby forming a first shoulder where the first rear wing meets the intermediate portion and a second shoulder where the second rear wing meets the intermediate portion;
a first edge tapering forwardly from the first rear wing to a point,
a second edge tapering forwardly from the second rear wing to the point; and
a pattern of wear resistant coating applied on a top side of the agricultural device at a first location at or near the tip and a second location at or near each of the first and second shoulders, wherein the pattern of wear resistant coating is configured to protect the agricultural device from a particular soil type.

6. The wear resistant agricultural device of claim 5 wherein the soil type comprises abrasive soil and the pattern of wear resistant coating comprises a generally triangular patch of wear resistant coating applied at the first location and generally square shaped patches of wear resistant coating applied at each of the second locations.

7. The wear resistant agricultural device of claim 5 wherein the soil type comprises rocky soil and the pattern of wear resistant coating comprises a generally square shaped patch of wear resistant coating applied at the first location and generally rectangular patches of wear resistant coating applied at each of the second locations.

8. The wear resistant agricultural device of claim 5 wherein the soil type comprises black soil and the pattern of wear resistant coating comprises a generally rectangular patch of wear resistant coating applied at the first location and generally rectangular patches of wear resistant coating applied at each of the second locations.

9. The wear resistant agricultural device of claim 5 wherein the pattern of wear resistant coating further comprises a generally circular patch of wear resistant coating applied at a third location at or near the shank portion.

10. The wear resistant agricultural device of claim 5 further comprising a line of wear resistant coating applied to at least a portion of the first and second edges on a bottom side of the agricultural device.
